(19) United States
(12) Patent Application Publication
(10) Pub. No.: US 2026/0214264 A1
(43) Pub. Date: Jul. 23, 2026

(54) METHOD AND APPARATUS FOR INTER-VIDEO SCREEN PREDICTION USING EVENT FRAMES

(71) Applicant: KWANGWOON UNIVERSITY INDUSTRY-ACADEMIC COLLABORATION FOUNDATION, Seoul (KR)

(72) Inventors: Dong Gyu SIM, Seoul (KR); Han Sol CHOI, Gyeonggi-do (KR)

(21) Appl. No.: 19/143,352

(22) PCT Filed: Oct. 25, 2023
(86) PCT No.: PCT/KR2023/016685

§ 371 Date: Jun. 25, 2025

(30) Foreign Application Priority Data
Dec. 26, 2022 (KR) 10-2022-0184849

(51) Int. Cl. H04N 19/587; H04N 19/105; H04N 19/159; H04N 19/172

(52) U.S. Cl. CPC H04N 19/587; H04N 19/105; H04N 19/159; H04N 19/172

(57) ABSTRACT

The present invention relates to encoding and decoding structures and methods for images acquired from a camera and events acquired from a DVS sensor and provides a method for generating a reference picture on the basis of a reconstructed event frame during an inter-screen prediction process in an image encoding/decoding process.

### TECHNICAL FIELD

The present invention relates to a structure and a method for encoding/decoding an image obtained from a camera and an event obtained from a DVS sensor, and provides a method for generating a reference picture based on a reconstructed event frame during an inter prediction process in an image encoding/decoding process.

### BACKGROUND ART

A camera is an optical sensor that outputs a pixel strength in a pixel-synchronous way. A DVS sensor is an event sensor that outputs a change in pixel strengths in a pixel-asynchronous way. The matched data of a camera and a DVS sensor can be utilized to analyze spatial information with high accuracy in a complementary manner, or can be compressed and stored or transmitted for the purpose of recording.

### DISCLOSURE

### Technical Problem

A multimodal system including a camera and a DVS sensor may be used in various applications that perform situation analysis based on spatial information. In this system, sensor data compression is essential to store sensor data obtained in real time in memory or transmit it to other devices. A multimodal system requires a technology to compress obtained data more efficiently compared to a single-modal system.

### Technical Solution

The image encoding method, the image decoding method and the recording medium of the present disclosure include a prediction signal obtaining step for obtaining a prediction signal by performing inter prediction based on an interpolation picture of a current picture and a reconstruction step for reconstructing the current picture based on the prediction signal and a residual signal of the current picture, wherein the interpolation picture may be obtained based on a polarity value of at least one event temporally between a reference picture of the current picture and the current picture, and when the reference picture is temporally earlier than the current picture, the interpolation picture may be obtained by adding the polarity value of the event to a corresponding pixel value of the reference picture, and when the reference picture is temporally later than the current picture, the interpolation picture may be obtained by subtracting the polarity value of the event from the corresponding pixel value of the reference picture.

In the image encoding method, the image decoding method and the recording medium of the present disclosure, for inter prediction based on the interpolation picture, a reference picture index, which is information of the inter prediction, may indicate the interpolation picture.

In the image encoding method, the image decoding method and the recording medium of the present disclosure, the event may be obtained from a bitstream.

In the image encoding method, the image decoding method and the recording medium of the present disclosure, the event may include a horizontal coordinate, a vertical coordinate, a polarity and a timestamp.

### Advantageous Effect

According to the present invention, a reference picture generation process utilizing an event frame may be performed in the inter prediction process of an image, and the compression efficiency of an image may be improved.

### BRIEF DESCRIPTION OF DRAWINGS

FIG. 1 shows image and event encoding systems.

FIG. 2 shows an event encoder performance process.

FIG. 3 shows an event structure and component.

FIG. 4 shows an image encoder performance process.

FIG. 5 shows a reference picture and an interpolation picture.

FIG. 6 shows image and event decoding systems.

FIG. 7 shows an event decoder performance process.

FIG. 8 shows an image decoder performance process.

### BEST MODE

The present invention relates to a structure and a method for encoding/decoding an image obtained from a camera and an event obtained from a DVS sensor, and proposes a method for generating a reference picture based on a reconstructed event frame during an inter prediction process in an image encoding/decoding process.

### MODE FOR INVENTION

Hereinafter, referring to attached drawings, the embodiment of the present invention will be described in detail so that those skilled in the art may easily implement it in the technical field to which the present invention belongs. However, the present invention may be implemented in different forms and is not limited to embodiments described herein. In addition, in order to clearly explain the present invention in drawings, parts that are not related to the description are omitted, and similar drawing signs are attached to similar parts throughout the specification.

Throughout the specification, when a part is said to be connected to another part, it includes not only a case where it is directly connected, but also a case where it is electrically connected with other elements in between. In addition, when a part is said to include a component, it means that instead of excluding other components, other components may be further included, unless otherwise specifically opposed.

Throughout the specification, when a part is said to include a component, it means that instead of excluding other components, other components may be further included, unless otherwise specifically opposed. The term of degree such as ‘step for~’ or ‘step of~’ used throughout the specification does not mean a step for~.

In addition, although terms ‘first’, ‘second’, etc. may be used to describe various components, the components should not be limited by the terms. The terms are used only to distinguish one component from other components.

In addition, as construction units shown in an embodiment of the present disclosure are independently shown to represent different characteristic functions, it does not mean that each construction unit is composed in a construction unit of separate hardware or one software. In other words, as each construction unit is described by being enumerated as each construction unit for convenience of a description, at least two construction units of each construction unit may be combined to form one construction unit or one construction unit may be divided into a plurality of construction units to perform a function. An integrated embodiment and a separate embodiment of each construction unit are also included in a scope of a right of the present disclosure unless they are beyond the essence of the present disclosure.

First, terms used herein are briefly described as follows.

A video decoding apparatus described below may be a device included in a server terminal such as a personal computer (PC), a laptop computer, a portable multimedia player (PMP), a wireless communication terminal, a smart phone, a TV application server, a service server, etc., and may refer to various devices including a user terminal such as various devices, a communication device such as a communication modem, etc. for communicating with a wired or wireless communication network, a memory for storing various programs and data for decoding an image or performing inter or intra prediction for decoding and a microprocessor for executing a program and calculating and controlling the program.

In addition, an image encoded into a bitstream by an encoder may be transmitted to an image decoding apparatus through a wired or wireless communication network such as the Internet, a wireless local area network, a wireless LAN network, a wibro network, a mobile communication network, etc. or through various communication interfaces such as a cable, a universal serial bus (USB), etc. in real time or non-real time and may be decoded, reconstructed and played back as an image.

Typically, a video may be composed of a series of pictures, and each picture may be partitioned into a high-level coding structure such as a slice and a tile and a coding unit in the form of a block such as a CTB, a PB and a CB. In addition, according to an embodiment, a coding structure and a block may also be partitioned into a circle or an irregular form as well as a polygonal form such as a triangle, a rhombus, a parallelogram, etc. not a square or a rectangle.

Those skilled in the art will understand that a term ‘Picture’ described below may be used by being replaced with other terms having an equivalent meaning such as an image, a frame, etc.

Hereinafter, the embodiment of the present invention will be described in more detail by referring to attached drawings. In describing the present invention, the overlapping description of the same components is omitted.

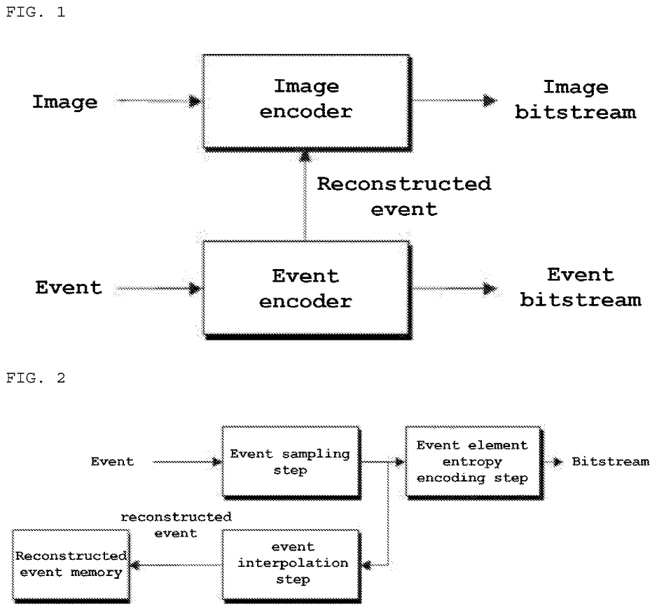

FIG. 1 shows image and event encoding systems.

An image and an event may be encoded independently. On the contrary, an image and an event may be encoded dependently. As an example, reconstructed event information may be used in an image encoder that encodes an image. As an example, reconstructed image information may be used in an event encoder that encodes an event.

FIG. 2 shows an event encoder performance process.

An event encoding method may be composed of at least one of an event sampling step, an event element entropy encoding step or an event interpolation step.

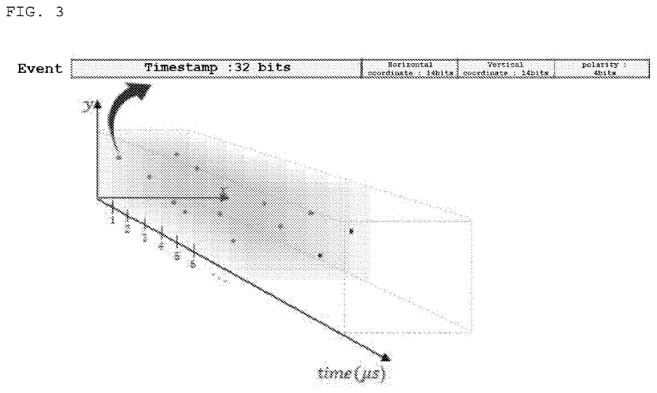

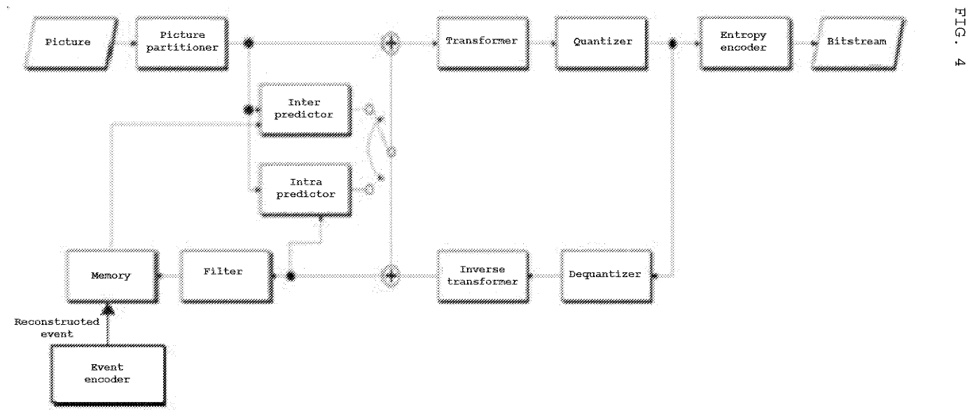

The structure of an event input to an event encoder and an element configuring an event may be the same as in FIG. 3.

In other words, an event sampling step may be performed based on an event. In addition, based on a sampling result, an event element entropy encoding step may be performed to generate a bitstream. In addition, based on a sampling result, an event interpolation step may be performed to generate a reconstructed event. In addition, a reconstructed event may be stored in reconstructed event memory.

An event may include a horizontal coordinate, a vertical coordinate, a polarity and a timestamp. For example, one event has a total of 64 bits and may include a 32-bit timestamp, a 14-bit horizontal coordinate, a 14-bit vertical coordinate and a 4-bit polarity as a component.

In the event sampling step of FIG. 2, an event input to an event encoder may be sampled on a temporal axis or a spatial axis.

When sampling is performed on a temporal axis, at least one event with the same x and y coordinates that occurred within a temporal sampling window may be processed to derive one event. Multiple temporal sampling windows within one event sequence may have a constant size and may not overlap each other.

When sampling is performed on a spatial axis, at least one event with a coordinate within a spatial sampling window may be processed to derive one event. The spatial sampling window may be obtained by partitioning the maximum spatial area by a grid of a certain size based on the x and y resolution of an event.

An event element entropy encoding step in FIG. 2 may perform entropy encoding by grouping one type of elements into one group from multiple sampled events. Entropy encoding may be one of the methods such as Exponential Golomb, Context-Adaptive Variable Length Coding (CAVLD), Context-Adaptive Binary Arithmetic Coding (CABAC), Variable Length Coding (VLC), etc.

An event interpolation step in FIG. 2 may interpolate one sampled event within a temporal/spatial sampling window to generate multiple events within a temporal/spatial sampling window. For example, when it is a temporal/spatial sampling window where a sampled event exists, a temporal/spatial sampling window may be partitioned into equal sub-windows and one event may be generated for each sub-window.

FIG. 4 shows an image encoder performance process.

A picture partitioner may partition a picture into sub-pictures, slices, tiles, coding tree units, etc. A coding tree unit may be partitioned into coding units based on at least one partition mode of a quadtree, a binary tree or a triple tree.

An intra predictor may generate a prediction signal based on reference pixel information around a prediction unit. A prediction signal may be generated by using a prediction mode such as a directional mode, a non-directional mode, a matrix

An inter predictor may generate a prediction signal based on the information of at least one picture of the previous picture or the subsequent picture of a current picture. An inter prediction method may include a step such as reference picture interpolation, motion prediction, motion compensation, etc.

A transformer may transform a residual signal by using a transform type such as DCT, DST, etc. Here, a residual signal may be obtained based on a prediction signal and an original signal.

A quantizer may quantize values transformed by a transformer to a frequency domain. A quantization coefficient may vary depending on the characteristics of a block. Here, the characteristics of a block may include the size, form, prediction mode, partition depth, etc. of a block.

An entropy encoder may use various encoding methods such as Exponential Golomb, Context-Adaptive Variable Length Coding (CAVLC), and Context-Adaptive Binary Arithmetic Coding (CABAC) for a quantized signal and additional coding information.

A filter may perform at least one of a deblocking filter, offset modification or Adaptive Loop Filter (ALF).

In the inter predictor of FIG. 4, a reconstructed picture or an interpolation picture in a reference picture list may be referenced to generate the inter prediction signal of a current picture to be currently encoded. The reconstructed picture may be encoded and decoded before a current picture and stored in memory. The interpolation picture may be generated by adding a reconstructed event to a reconstructed picture.

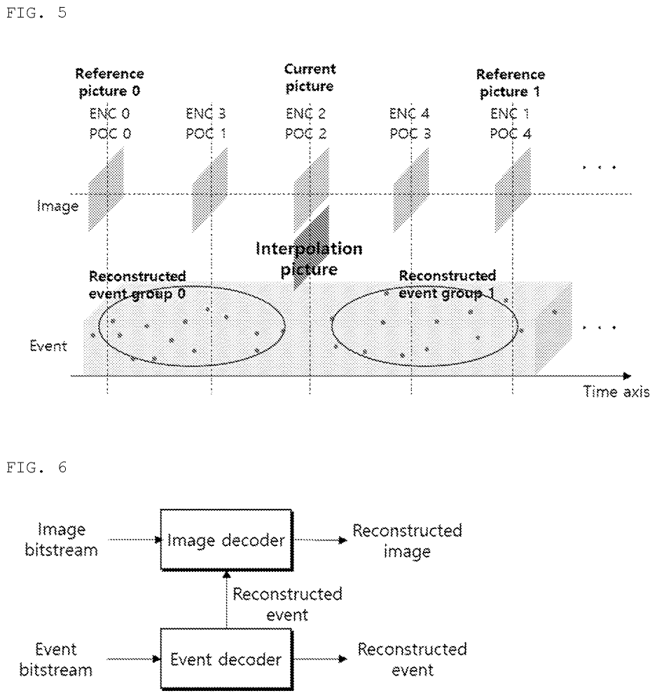

FIG. 5 shows a reference picture and an interpolation picture.

FIG. 5 may represent a current picture, the reference picture of a current picture, an event reconstructed at a current time and an interpolation picture. At least one reference picture that may be referenced by a current picture may be added to a reference picture list. For each reference picture, the polarity value of at least one reconstructed event temporally between a reference picture and a current picture may be added to or subtracted from the corresponding pixel position of a reference picture to generate an initial interpolation picture.

As an example, when a reference picture is temporally earlier than a current picture, the polarity value of a reconstructed event may be added to the corresponding pixel value of a reference picture.

As an example, when a reference picture is temporally later than a current picture, the polarity value of a reconstructed event may be subtracted from the corresponding pixel value of a reference picture.

An interpolation picture may be generated by averaging at least one generated initial interpolation picture. A generated interpolation picture may be added to a reference picture list.

In a current picture, a motion search may be performed in a reference picture within a reference picture list in the unit of a coding unit, and a reference picture index and a motion vector determined by a motion search result may be encoded and transmitted.

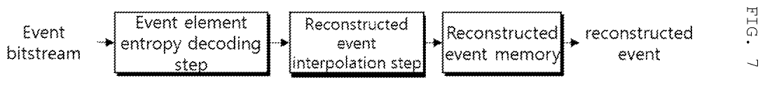

FIG. 6 shows image and event decoding systems.

FIG. 6 may represent the process of an image and event decoding system. An event decoder may receive and reconstruct an event bitstream to output a reconstructed event. An image decoder may receive an image bitstream and use a reconstructed event to reconstruct and output a reconstructed image.

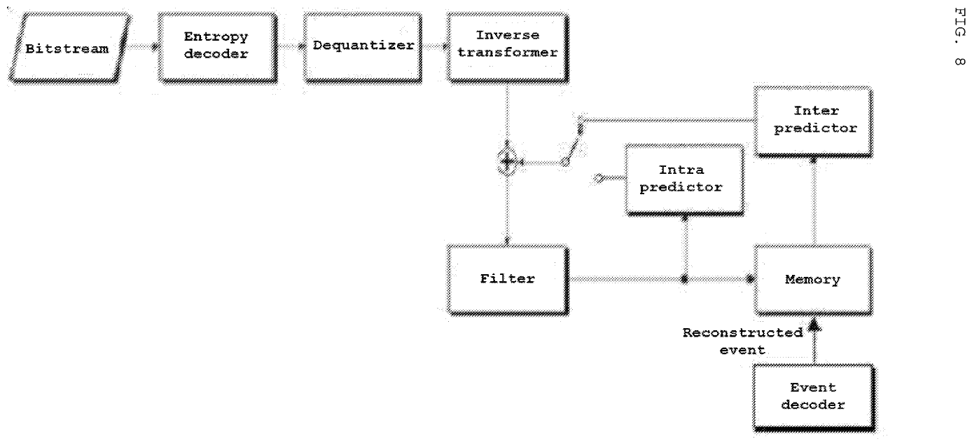

FIG. 7 shows an event decoder performance process.

An event element entropy decoding step in FIG. 7 may perform entropy decoding for each event element. Entropy decoding may be one of the methods such as Exponential Golomb, Context-Adaptive Variable Length Decoding (CAVLD), Context-Adaptive Binary Arithmetic Decoding (CABAD), Variable Length Decoding (VLD), etc.

An event interpolation step in FIG. 7 may interpolate one reconstructed event within a temporal/spatial sampling window to generate multiple events within a temporal/spatial sampling window. As an example, when it is a temporal/spatial sampling window where a reconstructed event exists, a temporal/spatial sampling window may be partitioned into equal sub-windows and one event may be generated for each sub-window.

FIG. 8 shows an image decoder performance process.

FIG. 8 may represent the performance process of an image decoder.

An entropy decoder may use various encoding methods such as Exponential Golomb, Context-Adaptive Variable Length Decoding (CAVLD) and Context-Adaptive Binary Arithmetic Decoding (CABAD) to reconstruct a quantized signal and additional coding information.

A dequantizer may generate a transform signal by performing quantization on a quantized signal according to a quantization coefficient.

An inverse transformer may perform inverse transform on a transform signal to generate a residual signal.

An intra predictor may generate a prediction signal based on reference pixel information around a prediction unit. A prediction signal may be generated by using a prediction mode such as a directional mode, a non-directional mode, a matrix product-based mode, etc.

An inter predictor may generate a prediction signal based on the information of at least one picture of the previous picture or the subsequent picture of a current picture. It may include a step such as reference picture interpolation, motion compensation, etc.

Based on a prediction signal and a residual signal, a current picture may be reconstructed.

A filter may perform at least one of a deblocking filter, an offset modifier or Adaptive Loop Filter (ALF).

In the inter predictor of FIG. 8, a reconstructed picture or an interpolation picture in a reference picture list may be referenced to generate the inter prediction signal of a current picture to be currently decoded. The reconstructed picture may be decoded before a current picture and stored in memory. The interpolation picture may be generated by adding a reconstructed event to a reconstructed picture.

A reference picture index and a motion vector may be decoded as the inter reference information of the current coding block of a current picture. When a picture indicated by a reference picture index is a reconstructed picture, an interpolation picture generation process may not be performed, and when a picture indicated by a reference picture index is an interpolation picture, an interpolation picture generation process may be performed as follows.

For each reference picture in a reference picture list, the polarity value of at least one reconstructed event temporally between a reference picture and a current picture may be added to or subtracted from the corresponding pixel position of a reference picture to generate an initial interpolation picture.

As an example, when a reference picture is temporally earlier than a current picture, the polarity value of a reconstructed event may be added to the corresponding pixel value of a reference picture.

As an example, when a reference picture is temporally later than a current picture, the polarity value of a reconstructed event may be subtracted from the corresponding pixel value of a reference picture.

An interpolation picture may be generated by averaging at least one generated initial interpolation picture. A generated interpolation picture may be added to a reference picture list. A block indicated by a motion vector in the reference picture of a current block may be derived as a reference block.

The exemplary methods of the present disclosure are described as a series of operations for clarity of explanation, but this is not intended to limit the order in which the steps are performed, and when necessary, each step may be performed simultaneously or in a different order. In order to implement a method according to the present disclosure, another step may be additionally included in an exemplary step or the remaining steps may be included excluding some steps or another additional step may be included excluding some steps.

The various embodiments of the present disclosure do not list all possible combinations, but are intended to describe the representative aspect of the present disclosure, and matters described in various embodiments may be applied independently or in a combination of at least two.

In addition, the various embodiments of the present disclosure may be implemented by hardware, firmware, software or a combination thereof. For implementation by hardware, they may be implemented by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), general processors, controllers, microcontrollers, microprocessors, etc.

The range of the present disclosure includes software or machine-executable instructions (i.e., an operating system, an application, firmware, a program, etc.) that enable operations according to the methods of various embodiments to be executed on a device or computer, and a non-transitory computer-readable medium in which such software or instructions are stored and executable on a device or computer.

### INDUSTRIAL APPLICABILITY

The present disclosure may be utilized in the encoding and decoding fields of an event image.

1. An image decoding method, the method comprising:
a prediction signal obtaining step for obtaining a prediction signal by performing an inter prediction based on an interpolation picture of a current picture; and
a reconstruction step for reconstructing the current picture based on the prediction signal and a residual signal of the current picture,
wherein the interpolation picture is obtained based on a polarity value of at least one event temporally between a reference picture of the current picture and the current picture,
wherein when the reference picture is temporally earlier than the current picture, the interpolation picture is obtained by adding the polarity value of the event to a corresponding pixel value of the reference picture, and
wherein when the reference picture is temporally later than the current picture, the interpolation picture is obtained by subtracting the polarity value of the event from the corresponding pixel value of the reference picture.

2. The method of claim 1, wherein:
for an inter prediction based on the interpolation picture, a reference picture index which is information of the inter prediction indicates the interpolation picture.

3. The method of claim 1, wherein:
the event is obtained from a bitstream.

4. The method of claim 1, wherein:
the event includes a horizontal coordinate, a vertical coordinate, a polarity and a timestamp.

5. An image encoding method, the method comprising:
a prediction signal obtaining step for obtaining a prediction signal by performing an inter prediction based on an interpolation picture of a current picture; and
an encoding step for encoding a residual signal of the current picture based on the prediction signal,
wherein the interpolation picture is obtained based on a polarity value of at least one event temporally between a reference picture of the current picture and the current picture,
wherein when the reference picture is temporally earlier than the current picture, the interpolation picture is obtained by adding the polarity value of the event to a corresponding pixel value of the reference picture, and
wherein when the reference picture is temporally later than the current picture, the interpolation picture is obtained by subtracting the polarity value of the event from the corresponding pixel value of the reference picture.

6. The method of claim 5, wherein:
based on an inter prediction based on the interpolation picture, it is determined that a reference picture index which is information of the inter prediction indicates the interpolation picture.

7. The method of claim 5, wherein:
the event is encoded into a bitstream.

8. The method of claim 5, wherein:
the event includes a horizontal coordinate, a vertical coordinate, a polarity and a timestamp.

9. A computer-readable recording medium storing a bitstream generated by an image encoding method, wherein the image encoding method includes:
a prediction signal obtaining step for obtaining a prediction signal by performing an inter prediction based on an interpolation picture of a current picture; and
an encoding step for encoding a residual signal of the current picture based on the prediction signal,
wherein the interpolation picture is obtained based on a polarity value of at least one event temporally between a reference picture of the current picture and the current picture,
wherein when the reference picture is temporally earlier than the current picture, the interpolation picture is obtained by adding the polarity value of the event to a corresponding pixel value of the reference picture, and
wherein when the reference picture is temporally later than the current picture, the interpolation picture is obtained by subtracting the polarity value of the event from the corresponding pixel value of the reference picture.

10. The medium of claim 9, wherein:
based on an inter prediction based on the interpolation picture, it is determined that a reference picture index which is information of the inter prediction indicates the interpolation picture.

11. The medium of claim 9, wherein:
the event is encoded into the bitstream.

12. The medium of claim 9, wherein:
the event includes a horizontal coordinate, a vertical coordinate, a polarity and a timestamp.
